(19) United States
(12) Patent Application Publication
(10) Pub. No.: US 2025/0356656 A1
(43) Pub. Date: Nov. 20, 2025

(54) COUNTING DEVICE, COUNTING METHOD, AND COMPUTER PROGRAM FOR COUNTING

(71) Applicants: TOYOTA JIDOSHA KABUSHIKI KAISHA, Toyota-shi Aichi-ken (JP); AISIN CORPORATION, Kariya Aichi (JP)

(72) Inventors: Hiroshi Yokoyama, Koto-ku Tokyo-to (JP); Takuya Hashikawa, Minato-ku Tokyo-to (JP)

(73) Assignees: TOYOTA JIDOSHA KABUSHIKI KAISHA, Toyota-shi Aichi-ken (JP); AISIN CORPORATION, Kariya Aichi (JP)

(21) Appl. No.: 19/204,732

(22) Filed: May 12, 2025

(30) Foreign Application Priority Data
May 17, 2024 (JP) 2024-081204

(51) Int. Cl. G06V 20/52; G06T 7/70; G06V 20/59

(52) U.S. Cl. CPC G06V 20/52; G06T 7/70; G06V 20/59; G06T 2207/30196; G06T 2207/30242

(57) ABSTRACT

A counting device includes a processor configured to: detect one or more persons in a predetermined region from each of a plurality of time-series images, track, for each of the one or more detected persons, the person in one or more images representing the person among the plurality of images, determine whether the position in the images of each of the one or more detected persons is within a hiding determination area in a region in the images corresponding to the predetermined region, based on the result of tracking, and count, when duration during which the position in the images of any of the one or more detected persons is outside the hiding determination area is not less than a predetermined time threshold, the number of the one or more persons represented in an image during the duration as the number of those remaining in the predetermined region.

### CROSS-REFERENCE TO RELATED APPLICATIONS

This application claims priority to Japanese Patent Application No. 2024-081204 filed May 17, 2024, the entire contents of which are herein incorporated by reference.

### FIELD

The present disclosure relates to a counting device, a counting method, and a computer program for counting the number of persons in a predetermined region.

### BACKGROUND

A technique for counting the number of people who have got into or out of a vehicle on the basis of a moving image including an entrance/exit of the vehicle has been proposed (see Japanese Unexamined Patent Publication No. 2022-149027).

### SUMMARY

In cases such as when the interior of a vehicle is crowded, multiple persons appear to overlap when viewed from a camera. In such cases, someone may be hidden by another person, making it difficult to correctly count the number of people who have got into or out of the vehicle or the number of people remaining in the vehicle.

It is an object of the present disclosure to provide a counting device that can count the number of persons in a predetermined region correctly.

In an aspect of the present disclosure, a counting device is provided, which includes a processor configured to: detect one or more persons in a predetermined region from each of a plurality of time-series images generated by a camera configured to capture the predetermined region, track, for each of the one or more detected persons, the person in one or more images representing the person among the plurality of images, determine whether the position in the images of each of the one or more detected persons is within a hiding determination area in a region in the images corresponding to the predetermined region, based on the result of tracking, and count, when duration during which the position in the images of any of the one or more detected persons is outside the hiding determination area is not less than a predetermined time threshold, the number of the one or more persons represented in an image during the duration as the number of those remaining in the predetermined region.

In an embodiment, the processor is further configured to count, when the duration is less than the time threshold after counting of the number of those remaining in the predetermined region, the number of persons who have crossed an adjacent region next to an entrance and exit of the predetermined region from the entrance and exit to the inside of the predetermined region among the one or more detected persons as the number of enterers and the number of persons who have crossed the adjacent region from the inside of the predetermined region to the entrance and exit as the number of leavers, based on the result of tracking, and correct the number of those remaining in the predetermined region by adding the number of leavers subtracted from the number of enterers to the number of those remaining in the predetermined region.

In an embodiment, the processor detects, for each of the one or more persons, a head region representing a head of the person and a human region representing a trunk of the person, respectively, from the images; the processor tracks the head region and the human region for each of the one or more persons; the processor counts the number of the human regions represented in an image during the duration as the number of those remaining in the predetermined region; and the processor counts the numbers of enterers and leavers, based on the result of tracking of the head regions.

According to another embodiment, a counting method is provided. The counting method includes detecting one or more persons in a predetermined region from each of a plurality of time-series images generated by a camera configured to capture the predetermined region; tracking, for each of the one or more detected persons, the person in one or more images representing the person among the plurality of images; determining whether the position in the images of each of the one or more detected persons is within a hiding determination area in a region in the images corresponding to the predetermined region, based on the result of tracking; and counting, when duration during which the position in the images of any of the one or more detected persons is outside the hiding determination area is not less than a predetermined time threshold, the number of the one or more persons represented in an image during the duration as the number of those remaining in the predetermined region.

According to still another embodiment, a non-transitory recording medium that stores a computer program for counting is provided. The computer program includes instructions causing a computer to execute a process including detecting one or more persons in a predetermined region from each of a plurality of time-series images generated by a camera configured to capture the predetermined region; tracking, for each of the one or more detected persons, the person in one or more images representing the person among the plurality of images; determining whether the position in the images of each of the one or more detected persons is within a hiding determination area in a region in the images corresponding to the predetermined region, based on the result of tracking; and counting, when duration during which the position in the images of any of the one or more detected persons is outside the hiding determination area is not less than a predetermined time threshold, the number of the one or more persons represented in an image during the duration as the number of those remaining in the predetermined region.

The counting device of the present disclosure has an effect of being able to count the number of persons in a predetermined region correctly.

### BRIEF DESCRIPTION OF DRAWINGS

FIG. 1 schematically illustrates the configuration of a vehicle equipped with a counting device of an embodiment.

FIG. 2 illustrates the interior of the vehicle.

FIG. 3 schematically illustrates the configuration of the counting device.

FIG. 4 is a functional block diagram of a processor related to a counting process.

FIG. 5A is a schematic diagram for explaining the counting process.

FIG. 5B is a schematic diagram for explaining the counting process.

FIG. 5C is a schematic diagram for explaining the counting process.

FIG. 6 is an operation flowchart of the counting process.

### DESCRIPTION OF EMBODIMENTS

A counting device, a counting method executed by the counting device, and a computer program for counting will now be described with reference to the attached drawings. The counting device detects one or more persons in a predetermined region from each of a plurality of time-series images generated by an image capturing unit, and tracks the detected persons. Based on the result of tracking, the counting device determines whether the position in the images of each of the detected persons is within a hiding determination area in a region in the images corresponding to the predetermined region. When duration during which the position in the images of any person is outside the hiding determination area is not less than a predetermined time threshold, the counting device counts the number of persons represented in an image during the duration as the number of persons in the predetermined region (hereafter the “number of those remaining in a predetermined region”).

The following describes an example in which the counting device is used for counting the number of passengers in a vehicle that multiple passengers can get on. Passengers are an example of persons to be counted. However, the counting device is not limited to this example, and may be used for counting the number of those remaining in a predetermined region inside a moving object that passengers or crew members can get on, such as a railway vehicle, or inside a building or a facility.

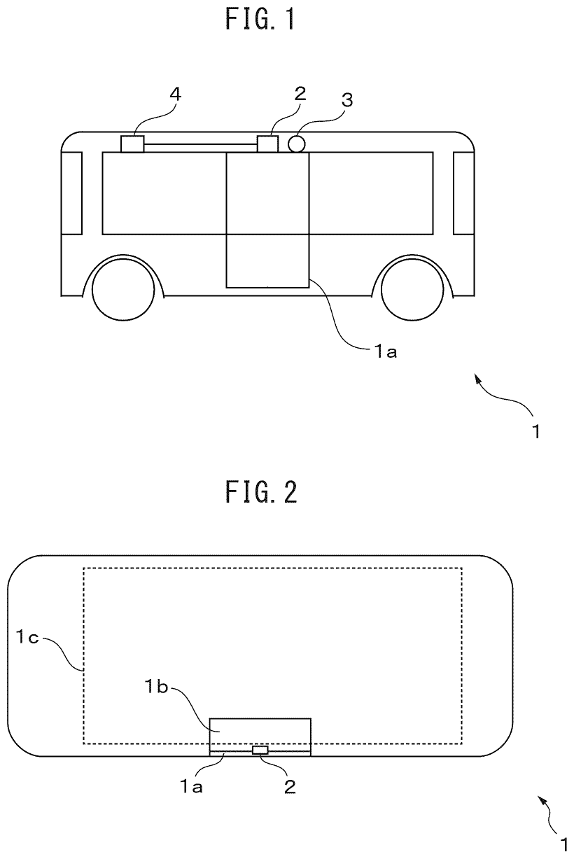

FIG. 1 schematically illustrates the configuration of a vehicle equipped with a counting device of an embodiment. FIG. 2 illustrates the interior of the vehicle equipped with the counting device, viewed from above. The vehicle 1 equipped with the counting device has enough interior space for multiple passengers to get on and to stand and move around, such as a bus. The vehicle 1 includes a camera 2, an alert device 3, and a counting device 4.

Inside the vehicle 1, an entrance region 1b is set around an entrance/exit 1a, which is an example of an entrance and exit of an interior region of the vehicle 1. The entrance region 1b, which is an example of the adjacent region next to an entrance and exit, is set as a region that is next to the entrance/exit 1a and through which passengers always pass when getting into or out of the vehicle 1 through the entrance/exit 1a.

The camera 2, which is an example of the image capturing unit, is mounted near the ceiling of the vehicle interior at the entrance/exit 1a of the vehicle 1 towards the bottom so that the area captured by the camera includes the whole interior region 1c where passengers can remain inside the vehicle 1. The interior region 1c is an example of the predetermined region captured by the image capturing unit. The camera 2 generates an image representing the interior region 1c every predetermined capturing period (e.g., 1/30 to 1/10 seconds). Every time an image is generated, the camera 2 outputs the generated image to the counting device 4 via an in-vehicle network.

The alert device 3 can issue a predetermined alert to passengers remaining inside the vehicle 1, includes, for example, a speaker, a buzzer, a beeper, or a display, and is mounted near the entrance/exit 1a or the ceiling inside the vehicle 1. According to an alert signal from the counting device 4, the alert device 3 outputs a voice representing a predetermined alert, e.g., an alert meaning a warning of the vehicle 1 being overloaded with passengers, or displays a message corresponding to this alert.

The counting device 4 executes a counting process, based on images generated by the camera 2.

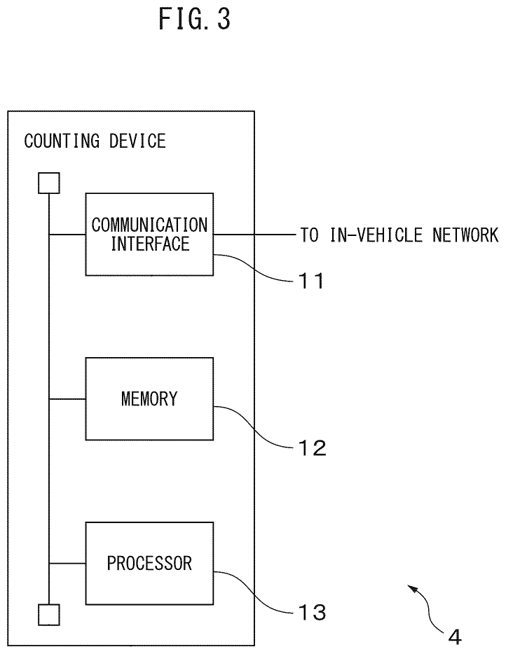

FIG. 3 illustrates the hardware configuration of the counting device 4. As illustrated in FIG. 3, the counting device 4 includes a communication interface 11, a memory 12, and a processor 13. The communication interface 11, the memory 12, and the processor 13 may be configured as separate circuits or a single integrated circuit.

The communication interface 11 includes an interface circuit for connecting the counting device 4 to the in-vehicle network. The communication interface 11 passes an image received from the camera 2 to the processor 13, and outputs an alert signal received from the processor 13 to the alert device 3.

The memory 12, which is an example of a storage unit, includes, for example, volatile and nonvolatile semiconductor memories. The memory 12 stores various programs and various types of data used in a counting process executed by the processor 13 of the counting device 4. For example, the memory 12 stores parameters for specifying a classifier used for detecting an occupant as well as the positions and ranges of various regions in images. In addition, the memory 22 temporarily stores images received from the camera 2 and various types of data generated during the counting process.

The processor 13 includes one or more central processing units (CPUs) and a peripheral circuit thereof. The processor 13 may further include another operating circuit, such as a logic-arithmetic unit, an arithmetic unit, or a graphics processing unit. The processor 13 executes the counting process.

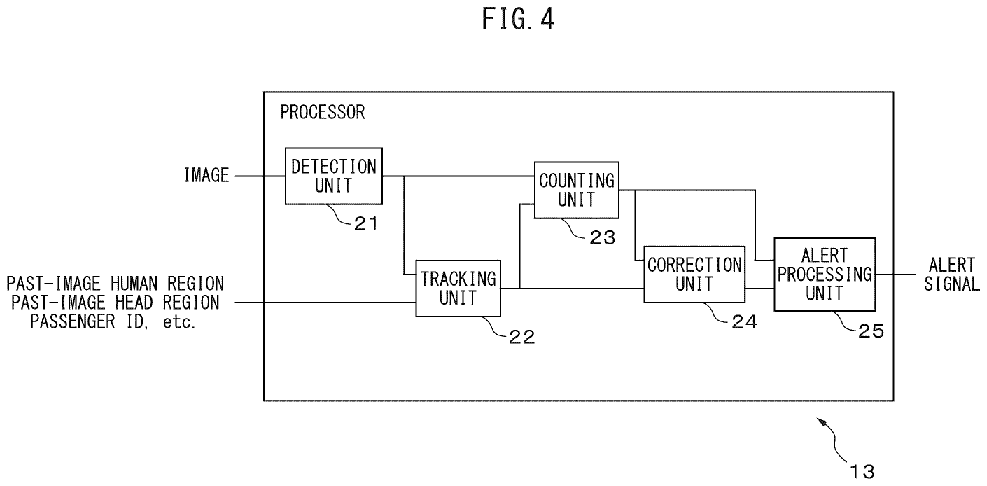

FIG. 4 is a functional block diagram of the processor 13 related to the counting process. The processor 13 includes a detection unit 21, a tracking unit 22, a counting unit 23, a correction unit 24, and an alert processing unit 25. These units included in the processor 13 are, for example, functional modules implemented by a computer program executed by the processor 13, or may be dedicated operating circuits provided in the processor 13.

The detection unit 21 detects a passenger in the interior region from each of a plurality of time-series images generated by the camera 2. In the present embodiment, the detection unit 21 detects a passenger at each predetermined period from the latest image obtained by the camera 2. The following describes a process for a single image because the detection unit 21 only needs to execute the same process for each image.

In the present embodiment, the detection unit 21 detects, for each passenger, a human region representing at least the passenger's trunk and a head region representing the passenger's head individually from an image. A human region may include not only a trunk but also another body part of a passenger, e.g., a head, an arm, a leg, or all of them. In the following description, a human region is assumed to include a passenger's trunk.

The detection unit 21 detects a passenger's trunk and head by inputting an image received by the counting device 4 from the camera 2 into a classifier that has been trained to detect these body parts of a passenger. As such a classifier is used one based on a “deep neural network (DNN).” For example, a DNN having architecture of a convolutional neural network (CNN) type, such as Single Shot MultiBox Detector or YOLO, or a DNN having an attention mechanism, such as Vision Transformer, is used as the classifier. Alternatively, a classifier based on another machine learning technique, such as AdaBoost, may be used as the classifier. The classifier is pre-trained, using a large number of training images including images representing a head and a trunk, in accordance with a predetermined training technique, such as backpropagation.

For various regions on the inputted image, the classifier outputs confidence scores for a head and a trunk indicating how likely it is that these body parts are represented therein. The detection unit 21 detects a region whose confidence score for a head is not less than a predetermined detection threshold as a head region, and a region whose confidence score for a trunk is not less than a predetermined detection threshold as a human region. When multiple human regions overlap, the detection unit 21 further executes Non-Maximum Suppression (NMS) or Soft NMS to prevent a single passenger from being detected multiple times. More specifically, the detection unit 21 calculates an Intersection over Union (IoU) of overlapping human regions, and discards human regions other than that which has a maximum confidence score when the IoU is not less than a predetermined threshold. Alternatively, the detection unit 21 reduces the confidence score as the IoU increases, and discards human regions whose reduced confidence scores are less than the predetermined detection threshold. The detection unit 21 also executes similar processing for overlapping head regions to prevent a single passenger's head from being detected multiple times.

For each passenger detected from the image, the detection unit 21 notifies the positions and ranges of the human region and the head region to the tracking unit 22, the counting unit 23, and the correction unit 24.

The tracking unit 22 tracks the detected passenger in one or more images representing the passenger among the plurality of time-series images generated by the camera 2. In the present embodiment, since each passenger's trunk and head are detected individually, the tracking unit 22 executes a tracking process for each of the detected passenger's trunk and head. More specifically, the tracking unit 22 associates human regions and head regions of the same passenger with each other over images for each passenger detected over the images. The following describes a tracking process for a human region, but the tracking unit 22 also executes the same process for a head region.

The tracking unit 22 applies a predetermined tracking technique, such as KLT tracking or ByteTrack, to each human region in the latest image. In this way, the tracking unit 22 associates each human region in the latest image with a human region of the same passenger who is detected in a previously obtained image (hereafter a “past image”) and who is being tracked. The tracking unit 22 tracks each passenger's trunk by repeating the above-described process whenever notified by the detection unit 21 of the result of detection in the latest image, assigns a unique identification number (hereafter a “passenger ID”) to each passenger's trunk being tracked, and determines a line connecting the centroid positions of individual human regions being tracked in chronological order as a trajectory of the passenger. The tracking unit 22 starts new tracking of a human region that is not associated with any human region representing a passenger being tracked in the past image among the human regions detected from the latest image, assuming that the passenger represented in the human region has entered the interior region anew. Conversely, when a human region of one of the passengers being tracked in the past image is not associated with any human region in the latest image, the tracking unit 22 finishes tracking of the passenger, assuming that the passenger being tracked has left the interior region.

In the present embodiment, the same passenger's trunk and head are detected and tracked individually as described above, and are thus assigned different passenger IDs.

The counting unit 23 determines whether the position in the images of each of the one or more detected passengers is within a hiding determination area in a region in the images corresponding to the interior region, based on the result of tracking by the tracking unit 22. When duration during which the position in the images of any of the one or more detected passengers is outside the hiding determination area is not less than a predetermined time threshold (e.g., several seconds to a dozen or so seconds), the counting unit 23 counts the number of one or more persons represented in an image during the duration and included in the interior region as the number of passengers remaining in the interior region.

The counting unit 23 may count the number of human regions or that of head regions in the interior region as the number of those remaining in the interior region. However, of the human regions and the head regions, in some embodiments, those which are detected more accurately in the interior region by the detection unit 21 are used for counting the number of those remaining in the interior region. For example, when human regions are detected more accurately than head regions, the counting unit 23 counts the number of human regions in the interior region as the number of those remaining in the interior region.

For each passenger in the interior region, the counting unit 23 may count him/her as a single passenger when a human region or a head region is detected. In this case, when the centroids of a human region and a head region are within a predetermined distance of each other, the counting unit 23 determines that the human region and the head region represent the same passenger. Alternatively, when an average of the differences between the positions of trajectories of a human region and a head region in individual images during tracking is not greater than a predetermined distance, the counting unit 23 may determine that the human region and the head region represent the same passenger.

When the number of those remaining in the interior region is counted based on human regions, the counting unit 23 counts human regions overlapping with the interior region by more than a predetermined percentage (e.g., 50 to 80%) among the human regions as ones included in the interior region. The same holds true for the case where the number of those remaining in the interior region is counted based on head regions. In addition, when a passenger's human region (or head region) overlaps with the hiding determination area by more than the predetermined percentage, the counting unit 23 determines that the position in the images of the passenger is within the hiding determination area. Alternatively, to determine whether a human region is within the hiding determination area, the counting unit 23 may estimate the position of the passenger's foot represented in the human region. When the estimated foot position is within the hiding determination area, the counting unit 23 determines that the position of the passenger represented in the human region is within the hiding determination area. In the present embodiment, the camera 2 is mounted on the ceiling of the vehicle interior towards the bottom. Thus the counting unit 23 estimates the position of a point of intersection of a line from a reference point in a human region to the vanishing point of the images with one of the sides of the human region to be a foot position of a passenger represented in the human region. The reference point may be set, for example, at the centroid position of the human region.

The counting unit 23 notifies the number of those remaining in the interior region to the correction unit 24 and the alert processing unit 25.

When the duration is less than the time threshold after counting of the number of those remaining in the interior region by the counting unit 23, the correction unit 24 counts, based on the result of tracking by the tracking unit 22 after this counting, the number of passengers who have crossed the entrance region 1b from the entrance/exit 1a to the inside of the interior region (hereafter “enterers”) among the one or more detected passengers as the number of enterers. In addition, the correction unit 24 counts the number of passengers who have crossed the entrance region 1b from the inside of the interior region to the entrance/exit 1a (hereafter “leavers”) as the number of leavers. The correction unit 24 then corrects the number of those remaining in the interior region by adding the number of leavers subtracted from the number of enterers to the number of those remaining in the interior region. The correction unit 24 can count the number of passengers staying inside the vehicle correctly by counting the number of passengers crossing the entrance region in this way when there is still a passenger within the hiding determination area.

To determine whether each passenger being tracked has crossed the entrance region 1b, the correction unit 24 refers to the trajectory of the passenger being tracked. The correction unit 24 determines a passenger whose trajectory enters the entrance region 1b from the side of the entrance region 1b closer to the entrance/exit 1a (hereafter simply the “entrance side”) and leaves the entrance region 1b from the side of the entrance region 1b inside the interior region (hereafter the “interior side”) as an enterer. Some passengers may be detected only after entry into the entrance region 1b. Thus the correction unit 24 may also determine a passenger who has left the entrance region 1b from the interior side among passengers whose first detected positions are inside the entrance region 1b and closer to the entrance side than to the interior side as an enterer. Similarly, the correction unit 24 determines a passenger whose trajectory enters the entrance region 1b from the interior side and leaves the entrance region 1b from the entrance side as a leaver. Tracking of some passengers may be finished before they get out of the vehicle from the entrance/exit 1a. Thus the correction unit 24 may also determine a passenger who has entered the entrance region 1b from the interior side and whose last detected position is closer to the entrance side than to the interior side inside the entrance region 1b as a leaver. However, the correction unit 24 does not count a passenger whose trajectory enters and leaves the entrance region from the entrance side as an enterer or a leaver. Similarly, the correction unit 24 does not count a passenger whose trajectory enters and leaves the entrance region from the interior side as an enterer or a leaver. In addition, the correction unit 24 may be configured not to count a passenger who has been in the entrance region for more than a certain period as an enterer or a leaver.

The correction unit 24 may count the numbers of enterers and leavers, based on trajectories of the head regions or the human regions of the respective detected passengers. However, of the human regions and the head regions, in some embodiments, the correction unit 24 uses those whose trajectories crossing the entrance region are determined more correctly for counting the numbers of enterers and leavers. For example, when trajectories of head regions are determined more correctly than trajectories of human regions, the correction unit 24 counts the numbers of enterers and those remaining in the interior region, based on the trajectories of the head regions of the respective detected passengers. In this way, the counting unit 23 and the correction unit 24 use either the human regions or the head regions, whichever are detected or tracked more accurately, resulting in the number of those remaining in the interior region being counted more correctly.

The difference between the numbers of enterers and leavers counted by the correction unit 24 may be counted as the number of those remaining in the interior region before the number of passengers staying inside the vehicle is counted by the counting unit 23.

Every time the number of those remaining in the interior region is corrected, the correction unit 24 notifies the corrected number of those remaining in the interior region to the alert processing unit 25.

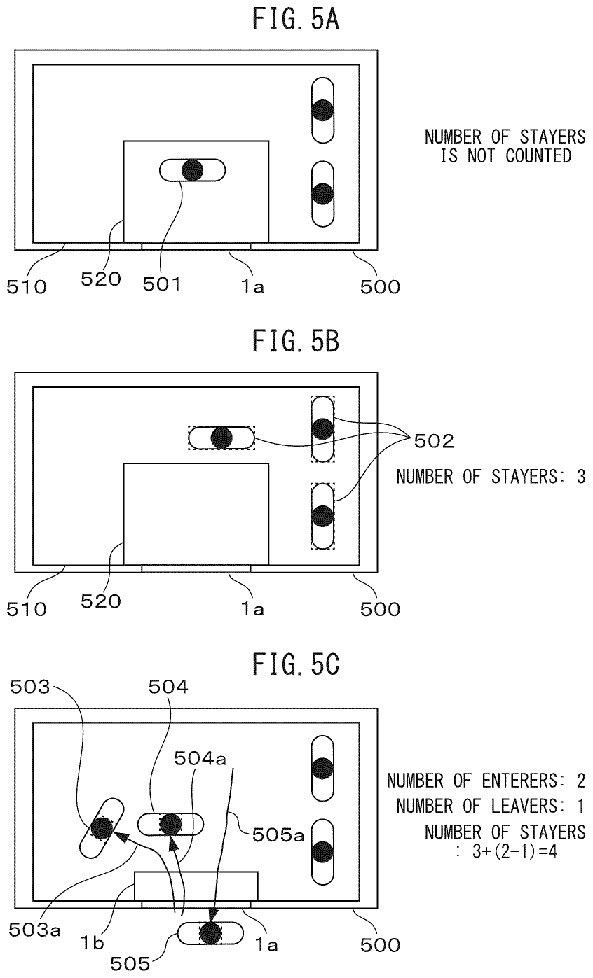

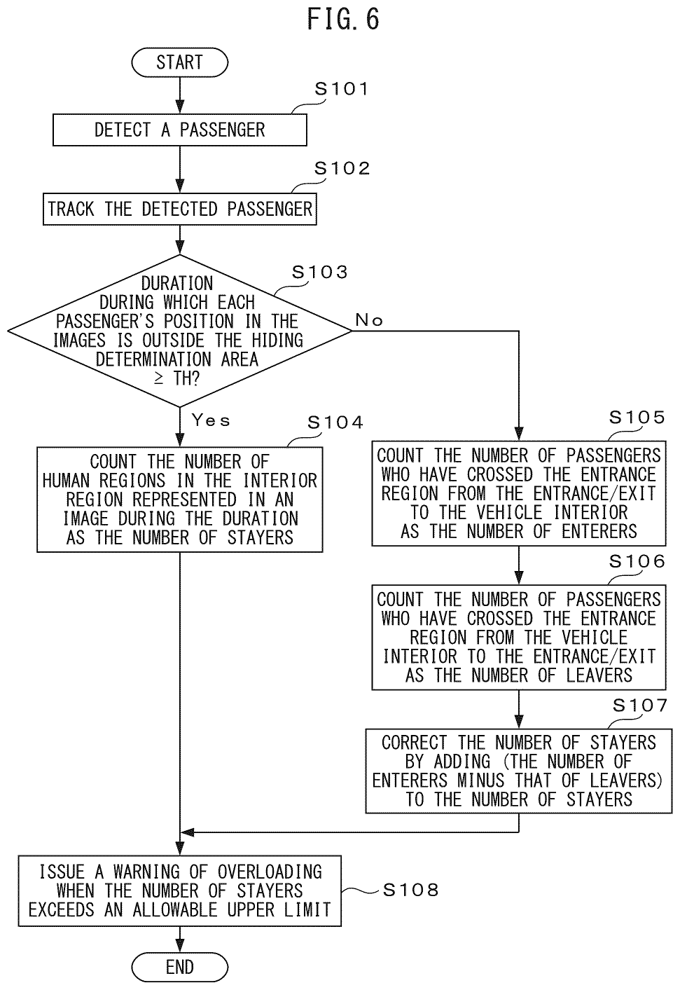

FIGS. 5A to 5C are schematic diagrams for explaining the process of counting the number of those remaining in the interior region. In these examples, the entrance/exit 1a is represented near the bottom of each image 500 illustrated in FIGS. 5A to 5C representing the interior region 1c of the vehicle 1.

In the example illustrated in FIG. 5A, a passenger 501 is within a hiding determination area 520 among passengers detected in an interior region 510 represented in the image 500. The hiding determination area 520 is set as an area where a passenger represented therein may hide another passenger as viewed from the camera 2. Hence, in the state of the example illustrated in FIG. 5A, the counting unit 23 does not count the number of those remaining in the interior region.

In the example illustrated in FIG. 5B, there is no passenger within the hiding determination area 520 in the image 500. Hence, when duration of the state of the example illustrated in FIG. 5B is not less than the time threshold, the counting unit 23 counts the number of human regions of respective passengers 502 detected from the interior region 510 as the number of those remaining in the interior region (in this example, 3 persons).

In the example illustrated in FIG. 5C, when duration during which there is no passenger within the hiding determination area is less than the time threshold, the numbers of enterers and leavers are counted based on trajectories of head regions of passengers crossing the entrance region 1b next to the entrance/exit 1a represented in the image 500. In this example, trajectories 503a and 504a of the head regions of passengers 503 and 504 cross the entrance region 1b from the entrance/exit 1a to the vehicle interior. Hence, the passengers 503 and 504 are counted as enterers (number of enterers: 2). Further, a trajectory 505a of the head region of a passenger 505 crosses the entrance region 1b from the vehicle interior to the entrance/exit 1a. Hence, the passenger 505 is counted as a leaver (number of leavers: 1). The corrected number of those remaining in the interior region is therefore 4 when the previous number of those remaining in the interior region is 3.

When the number of those remaining in the interior region notified by the counting unit 23 or the correction unit 24 exceeds an allowable upper limit, the alert processing unit 25 outputs an alert signal indicating a warning of overloading to the alert device 3 via the communication interface 11. Alternatively, the alert processing unit 25 may output a signal indicating overloading to an electronic control unit (ECU) that controls a door of the vehicle 1, via the communication interface 11. The ECU controls the door of the entrance/exit 1a so as to keep the door open while the signal indicating overloading is received.

The alert processing unit 25 may transmit the number of those remaining in the interior region at the time when the vehicle 1 reaches or departs from a predetermined location (e.g., a predetermined stopping place), to a device outside the vehicle 1 via a wireless communication terminal (not illustrated) mounted on the vehicle 1.

FIG. 6 is an operation flowchart of the counting process. The processor 13 executes the counting process in accordance with the operation flowchart described below.

The detection unit 21 detects a passenger from images generated by the camera 2 (step S101). The tracking unit 22 tracks the detected passenger (step S102).

It is determined whether duration during which any detected passenger is outside the hiding determination area is not less than a predetermined time threshold Th (step S103). When the duration is not less than the time threshold Th (Yes in step S103), the counting unit 23 counts the number of human regions in the interior region represented in an image obtained during the duration as the number of those remaining in the interior region (step S104).

When the duration is less than the time threshold Th (No in step S103), the correction unit 24 counts the number of passengers who have crossed the entrance region 1b represented in images from the entrance/exit 1a to the vehicle interior as the number of enterers, based on the result of tracking of head regions after the last counting of the number of those remaining in the interior region by the counting unit 23 (step S105). Similarly, based on the result of tracking, the correction unit 24 counts the number of passengers who have crossed the entrance region 1b represented in images from the vehicle interior to the entrance/exit 1a as the number of leavers (step S106). The correction unit 24 then corrects the number of those remaining in the interior region by adding the number of leavers subtracted from the number of enterers to the latest number of those remaining in the interior region (step S107).

After step S104 or S107, the alert processing unit 25 issues a warning of overloading to passengers in the vehicle via the alert device 3 when the number of those remaining in the interior region exceeds an allowable upper limit (step S108). The processor 13 then terminates the counting process.

As has been described above, the counting device determines whether the position in a plurality of time-series images of each person detected from the images and being tracked is within a hiding determination area in a region in the images corresponding to a predetermined region. When duration during which the position in the images of any person is outside the hiding determination area is not less than a predetermined time threshold, the counting device counts the number of persons in the predetermined region represented in an image during the duration as the number of those remaining in the interior region. In this way, the number of those remaining in the interior region is counted when no one is supposed to be hidden by another, enabling the counting device to count the number of those remaining in the predetermined region correctly.

According to a modified example, the counting unit 23 may enlarge the hiding determination area as the number of those remaining in the interior region before counting the latest number of those remaining in the interior region increases. When viewed from the camera 2, the area of someone hidden by another increases with the number of those remaining in the interior region. By increasing the size of the hiding determination area with the number of those remaining in the interior region, the counting unit 23 can decrease the possibility that someone is hidden by another at counting of the number of those remaining in the interior region.

The computer program causing a computer to execute the process executed by the processor 13 of the counting device 4 of the above-described embodiment or modified example may be recorded, for example, on a storage medium, such as an optical medium or a magnetic medium, and distributed.

As described above, those skilled in the art may make various modifications according to embodiments within the scope of the present disclosure.

What is claimed is:

1. A counting device comprising:
a processor configured to:
detect one or more persons in a predetermined region from each of a plurality of time-series images generated by a camera configured to capture the predetermined region,
track, for each of the one or more detected persons, the person in one or more images representing the person among the plurality of images,
determine whether the position in the images of each of the one or more detected persons is within a hiding determination area in a region in the images corresponding to the predetermined region, based on the result of tracking, and
count, when duration during which the position in the images of any of the one or more detected persons is outside the hiding determination area is not less than a predetermined time threshold, the number of the one or more persons represented in an image during the duration as the number of those remaining in the predetermined region.

2. The counting device according to claim 1, wherein the processor is further configured to:
count, when the duration is less than the time threshold after counting of the number of those remaining in a predetermined region, the number of persons who have crossed an adjacent region next to an entrance and exit of the predetermined region from the entrance and exit to the inside of the predetermined region among the one or more detected persons as the number of enterers and the number of persons who have crossed the adjacent region from the inside of the predetermined region to the entrance and exit as the number of leavers, based on the result of tracking, and
correct the number of those remaining in the predetermined region by adding the number of leavers subtracted from the number of enterers to the number of persons remaining in the predetermined region.

3. The counting device according to claim 2, wherein for each of the one or more persons, the processor detects a head region representing a head of the person and a human region representing a trunk of the person, respectively, from the images,
tracks the head region and the human region for each of the one or more persons,
counts the number of the human regions represented in an image during the duration as the number of those remaining in the predetermined region, and
counts the numbers of enterers and leavers, based on the result of tracking of the head regions.

4. A counting method comprising:
detecting one or more persons in a predetermined region from each of a plurality of time-series images generated by a camera configured to capture the predetermined region;
tracking, for each of the one or more detected persons, the person in one or more images representing the person among the plurality of images;
determining whether the position in the images of each of the one or more detected persons is within a hiding determination area in a region in the images corresponding to the predetermined region, based on the result of tracking; and
counting, when duration during which the position in the images of any of the one or more detected persons is outside the hiding determination area is not less than a predetermined time threshold, the number of the one or more persons represented in an image during the duration as the number of those remaining in the predetermined region.

5. A non-transitory recording medium that stores a computer program for counting, the computer program causing a computer to execute a process comprising:
detecting one or more persons in a predetermined region from each of a plurality of time-series images generated by a camera configured to capture the predetermined region;
tracking, for each of the one or more detected persons, the person in one or more images representing the person among the plurality of images;
determining whether the position in the images of each of the one or more detected persons is within a hiding determination area in a region in the images corresponding to the predetermined region, based on the result of tracking; and
counting, when duration during which the position in the images of any of the one or more detected persons is outside the hiding determination area is not less than a predetermined time threshold, the number of the one or more persons represented in an image during the duration as the number of those remaining in the predetermined region.
